(19) United States
(12) Patent Application Publication
(10) Pub. No.: US 2025/0093660 A1
(43) Pub. Date: Mar. 20, 2025

(54) EFFICIENCY-LADDERED CROPPED EXIT PUPIL EXPANDER FOR COMPACT DIFRACTIVE WAVEGUIDES

(71) Applicant: Applied Materials, Inc., Santa Clara, CA (US)

(72) Inventors: Simon LORENZO, Santa Clara, CA (US); David Alexander SELL, Santa Clara, CA (US)

(21) Appl. No.: 18/885,214

(22) Filed: Sep. 13, 2024

Related U.S. Application Data
(60) Provisional application No. 63/538,636, filed on Sep. 15, 2023.

(51) Int. Cl. G02B 27/01; G02B 6/34; G02B 6/42

(52) U.S. Cl. CPC G02B 27/0172; G02B 6/34; G02B 6/42; G02B 6/4206; G02B 2027/0123

(57) ABSTRACT

Embodiments of the present disclosure relate to devices and methods related to relate to augmented reality waveguide combiners. The device includes a waveguide combiner, the waveguide combiner includes an input coupler operable to receive a light and in-couple the light into the waveguide combiner, an exit pupil expander (EPE) adjacent to a grating of the input coupler, the EPE having a laddered structure, the laddered structure comprising at least one band, the at least one band comprising a plurality of grating structures, at least one grating structure of the plurality of grating structures has a varying depth, a varying duty cycle, or a varying pitch that is different than a depth, a duty cycle, or pitch than an adjacent grating structure of the plurality of grating structures, and an output coupler operable to receive the light from the EPE and transmit the light onto a user field of view (FOV).

### CROSS-REFERENCE TO RELATED APPLICATIONS

This application claims benefit of U.S. Provisional Patent Application Ser. No. 63/538,636, filed Sep. 15, 2023, which is herein incorporated by reference.

### BACKGROUND

### Field

Embodiments of the present disclosure generally relate to augmented reality waveguide combiners. More specifically, embodiments described herein relate to waveguide combiners with efficiency-laddered exit pupil expanders.

### Description of the Related Art

Virtual reality is generally a computer generated simulated environment in which a user has an apparent physical presence. A virtual reality experience may be generated from a three-dimensional (3D) perspective and viewed with a head-mounted display (HMD), such as glasses or other wearable display devices that have near-eye display panels as lenses to display a virtual reality environment that substantially replaces an actual environment.

Augmented reality (AR) enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

One such challenge is displaying a virtual image overlaid on an ambient environment. Waveguide combiners are used to assist in overlaying images. Generated light is in-coupled into a waveguide combiner, propagated through the augmented waveguide combiner, out-coupled from the augmented waveguide combiner, and overlaid on the ambient environment. Light is coupled into and out of augmented waveguide combiners using surface relief gratings.

Accordingly, what is needed in the art are waveguide combiners having efficiency-laddered exit pupil expanders that effectively transmit incident light to expand a user field of view (FOV).

### SUMMARY

In one embodiment, a device is disclosed. The device includes a waveguide combiner, the waveguide combiner includes an input coupler operable to receive a light and in-couple the light into the waveguide combiner, an exit pupil expander (EPE) adjacent to a grating of the input coupler, the EPE having a laddered structure, the laddered structure comprising at least one band, the at least one band comprising a plurality of grating structures, at least one grating structure of the plurality of grating structures has a varying depth, a varying duty cycle, or a varying pitch that is different than a depth, a duty cycle, or pitch than an adjacent grating structure of the plurality of grating structures, and an output coupler operable to receive the light from the EPE and transmit the light onto a user field of view (FOV).

In another embodiment, a device is disclosed. The device includes a substrate, a light engine disposed above the substrate, a waveguide combiner disposed on the substrate, the waveguide combiner comprising, an input coupler operable to receive a light and in-couple the light into the waveguide combiner, an exit pupil expander (EPE) adjacent to a grating of the input coupler, the EPE having a laddered structure, the laddered structure comprising at least one band, the at least one band comprising a plurality of grating structures, at least one grating structure of the plurality of grating structures has a varying depth, a varying duty cycle, or a varying pitch that is different than a depth, a duty cycle, or pitch than an adjacent grating structure of the plurality of grating structures, and an output coupler operable to receive the light from the EPE and transmit the light onto a user field of view (FOV), and the user FOV disposed adjacent to the waveguide combiner, the user FOV operable to receive the light from the waveguide combiner and display the light.

In another embodiment, a method is disclosed. The method includes in-coupling a light into a waveguide combiner, the waveguide combiner includes an input coupler operable to receive the light, an exit pupil expander (EPE) adjacent to a grating of the input coupler, the EPE having a laddered structure, the laddered structure comprising at least one band, the at least one band comprising a plurality of grating structures, at least one grating structure of the plurality of grating structures has a varying depth, a varying duty cycle, or a varying pitch that is different than a depth, a duty cycle, or pitch than an adjacent grating structure of the plurality of grating structures, and an output coupler, reflecting the light at the EPE, interacting the light within the EPE with the plurality of grating structures, and out-coupling the light at the output coupler, the output coupler operable to receive the light from the EPE and transmit the light onto a user field of view (FOV).

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A is a schematic top view of a waveguide combiner having an exit pupil expander (EPE), according to certain embodiments.

FIG. 1B is an example schematic view of the output of a waveguide combiner, according to certain embodiments.

FIG. 2A is a schematic top view of a first waveguide combiner having an efficiently laddered EPE, according to certain embodiments herein.

FIG. 2B is a schematic top view of a second waveguide combiner having an efficiently laddered EPE, according to certain embodiments herein.

FIGS. 3A, 3C, 3E, 3G, and 3I are examples of schematic top views of a second waveguide combiner having varying efficiently laddered EPE. FIGS. 3B, 3D, 3F, 3H, and 3J are example of cross-sectional side views of a plurality of grating structures, according to certain embodiments.

FIG. 3K is an example of a schematic top view of a first waveguide combiner, and FIG. 3L is an example of a cross-sectional side view of a plurality of grating structures, according to certain embodiments.

FIGS. 4A-4C are examples of schematic top vies of a plurality of grating structures, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to augmented reality waveguide combiners. More specifically, embodiments described herein relate to waveguide combiners with efficiently-laddered exit pupil expanders (EPEs). An efficiently laddered EPE is a grating disposed over a substrate of a waveguide combiner. As described herein, efficiently-laddered EPEs promote multiple interactions with light as the light moves laterally within the EPE. The efficiently laddered EPEs direct light away from cropped regions of the exit pupil expander. The cropped region may include an edge of the waveguide combiner or the edge of the substrate the waveguide combiner is disposed on. The efficiently laddered EPEs direct light toward the output coupler. The controlled direction of light within the efficiently-laddered EPE allows for a large user field of view (FOV).

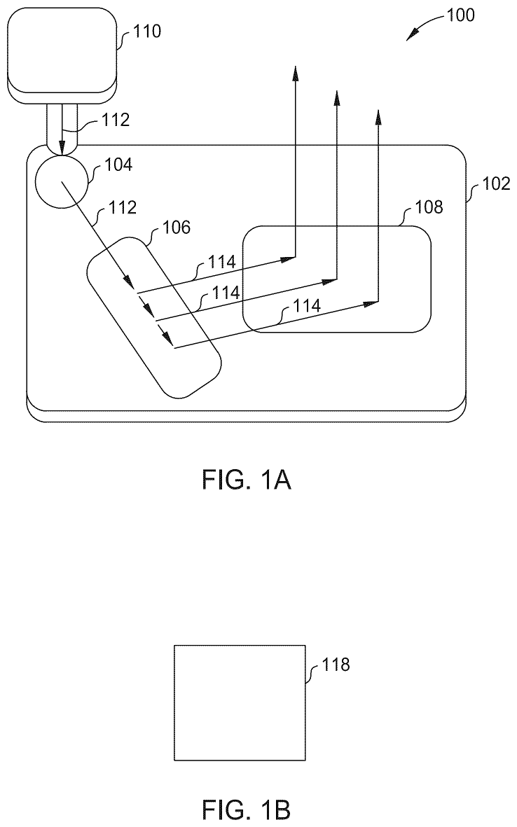

FIG. 1A is a schematic, top view of a waveguide combiner 100 in operation. The waveguide combiner 100 includes a substrate 102. An input coupler 104, an EPE 106, and an output coupler 108 are disposed in, on, or over the substrate 102. The input coupler 104 is aligned with a light engine 110. The light engine 110, in operation, projects incident beams (e.g., a virtual image) to the input coupler 104. The incident beams are shown as the input beam 112. The input coupler 104 receives the input beam 112. The input beam 112 is incoupled by in the input coupler 104 such that the input beam 112 undergoes total-internal-reflection (TIR) through the substrate 102 until the input beam 112 comes in contact with the grating structures of the EPE 106. The T1 beams 114 undergo TIR in the EPE 106 until the T1 beams 114 contact another grating structure. T-1 beams are then coupled to the output coupler 108. The T1 beams that undergo TIR in the EPE 106 continue to contact grating structures until either the intensity of the T1 beams 114 is depleted or remaining T1 beams 114 propagating through the EPE 106 reach the end of the EPE 106.

FIG. 1B is a schematic illustration of a user field of view (FOV) 118. The grating structures of the EPE must be tuned to control the T1 beams coupled in the EPE 106 in order to control the intensity of the T-1 beams coupled to the output coupler 108 to modulate the user FOV 118 produced from the micro display from a user's perspective and increase a viewing angle from which a user can view the virtual image. The larger user FOVs result in an increased viewing angle. It is desirable to increase the user FOV without increasing the surface area of the substrate 102.

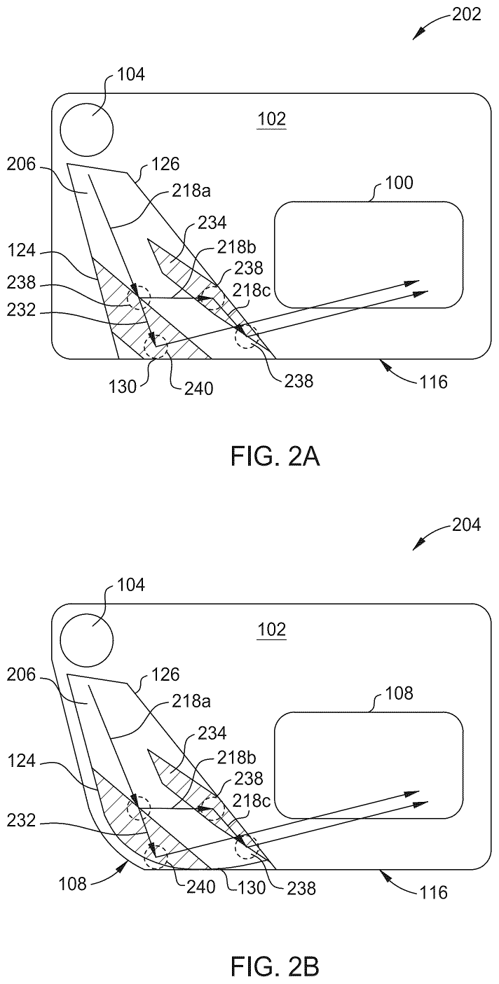

FIG. 2A is a schematic, top view of a first waveguide combiner 202. The first waveguide combiner 202 includes an efficiently laddered EPE 206. FIG. 2B is a schematic, top view of a second waveguide combiner 204 having an efficiently laddered EPE 206. The efficiently laddered EPE 206 has a first boundary 124, a second boundary 126, and a third boundary 130. The first boundary 124 and the second boundary 126 are angled from the input coupler 104, with first boundary 124 and the second boundary 126 extending from the input coupler 104. The third boundary 130 of the EPE 106 is along at least one edge of the substrate 102, such as an edge 116 (e.g., the grating structures 300 if the efficiently laddered EPE 206 extend to at least one edge, such as the edge 116 of the substrate 102). At least a portion of the second boundary 126 and the third boundary 130 of the efficiently laddered EPE 206 of the second waveguide combiner 204 are conformal to an edge 116 of the substrate 102.

In some embodiments, the efficiently laddered EPE 206 may be defined by a grating vector. The grating vector is a function of grating across the efficiently laddered EPE 206 material, which is a periodic optical structure that diffracts light into wavelength-dependent directions. The grating vector (k_{grating}) describes the periodicity and direction of the grating. Λₓ and Λ_{y} may define the periodicities in x and y, respectively. In k-space (wave number) plots, the grating vector is often normalized by k₀ which is the wave vector of light in free space. This normalized grating vector is now wavelength-dependent. A minimum grating region (MGR) for the efficiently laddered EPE 206 may be useful to support the entire waveguide combiner user FOV across the output. This is provided by the k-space diagrams and the maximum angular extents (MAE) of the grating vectors and FOV for each color. The MAE steepest slope lines intersecting the first boundary 124, the second boundary 126, and third boundary 130 of the gratings of the input coupler 104 and the output coupler 108 bound the MGR of the grating of the efficiently laddered EPE 206. In some cases, a larger FOV requires a larger efficiently laddered EPE 206 grating region.

The first waveguide combiner 202 and the second waveguide combiner 204 include a substrate 102, an input coupler 104, an efficiently laddered EPE 206, and an output coupler 108. The substrate 102 of the first waveguide combiner 202 and second waveguide combiner 204 contains the input coupler 104, the efficiently laddered EPE 206, and the output coupler 108. The input coupler 104 is capable of in-coupling light from a light engine 110 into the waveguide combiner (e.g., the first waveguide combiner 202 and the second waveguide combiner 204) and transmitting the light to the efficiently laddered EPE 206. The efficiently laddered EPE 206 includes a plurality of grating structures 300. In other embodiments, the light engine 110 generates light having one or more wavelengths and transmits the light to the input coupler 104. For example, the light engine 110 generates light having a single wavelength or range of wavelengths corresponding to a single color or group of colors. In other embodiments, a single color wavelength light is generated by the light engine 110 and transmitted to the input coupler 104. The light reflects off the efficiently laddered EPE 206 towards the output coupler 108, where it is out-coupled to a display (e.g., the user FOV). The size of the efficiently laddered EPE 206 is related to the input coupler 104 and the shape of the waveguide combiner (e.g., the first waveguide combiner and the second waveguide combiner). For example, as shown in FIG. 2A, the first waveguide combiner 202 includes a substrate 102 with a rectangular shape. As a further example, as shown in FIG. 2B, the second waveguide combiner 204 includes a substrate 102 with a rounded edge portion 120. The efficiently laddered EPE 206 is disposed over the rounded edge portion 120 of the second waveguide combiner 204.

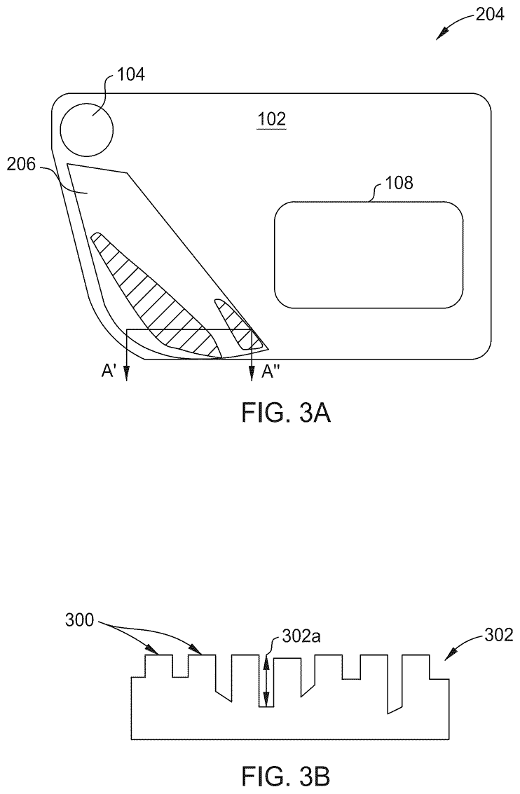

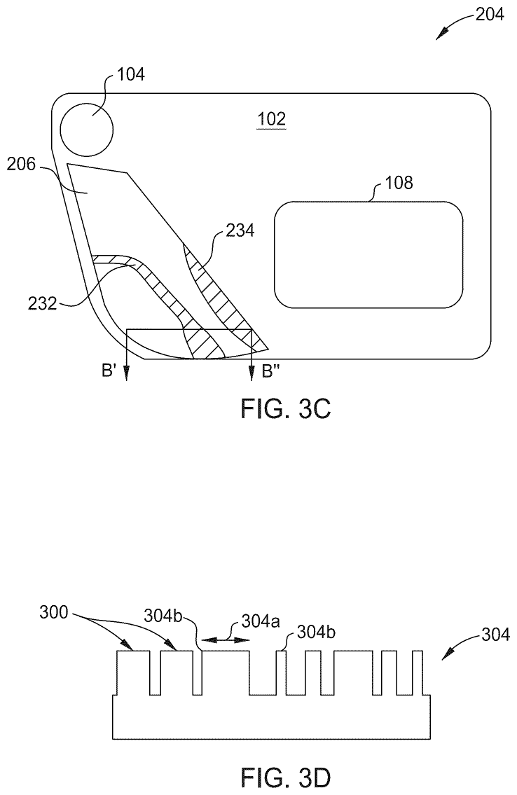

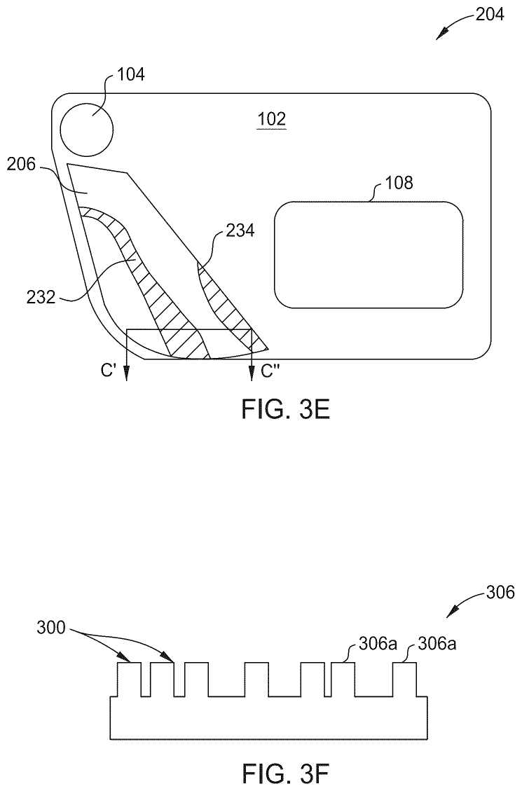

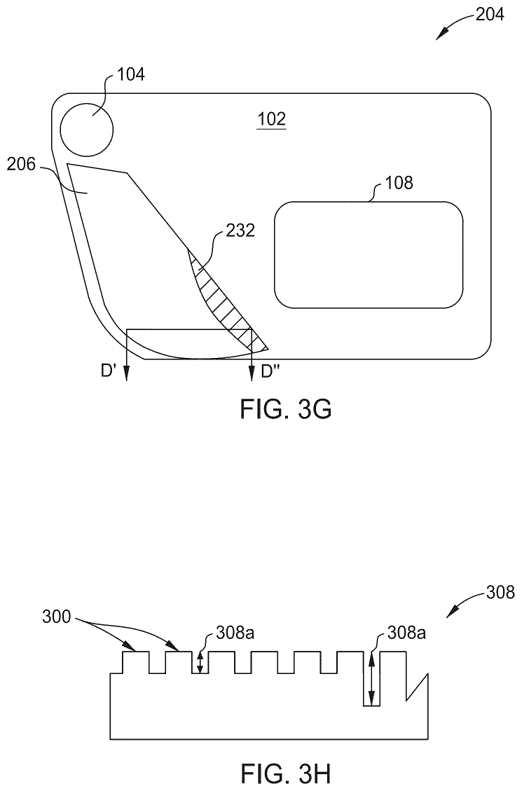

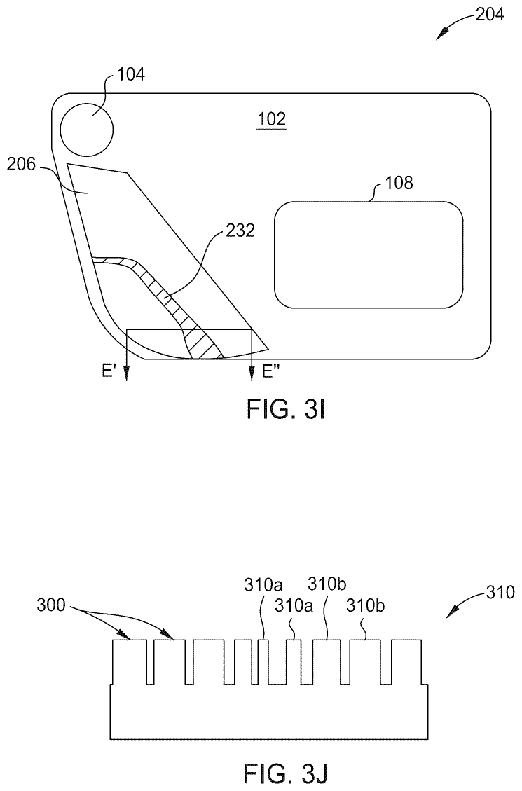

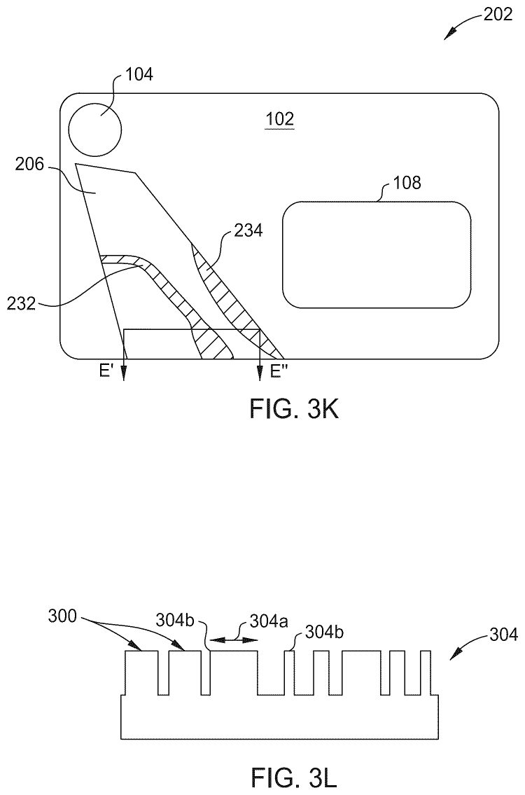

The efficiently laddered EPE 206 includes increased grating efficiency diagonally across the efficiently laddered EPE 206 to promote light (e.g., the light 218a, the light 218b or the light 218c) moving laterally within the efficiently laddered EPE 206 and away from the edge 116 of the substrate 102. For example, the efficiently laddered EPE 206 includes a plurality of bands (e.g., a first band 232 and a second band 234). Each band (e.g., a first band 232 and a second band 234) includes a plurality of grating structures 300, which include a varying depth, a varying duty cycle, and/or a varying pitch, that form high efficiency gratings (see FIGS. 3A-3J). Alternatively or additionally, the efficiently laddered EPE 206 may include one efficiently laddered band (e.g., a first band 232). A first band 232 within the efficiently laddered EPE 206 redirects light 218a away from the edge 116. For example, when light 218a is directed toward the edge 116 there may be a missing interaction 240. The missing interaction 240 allows for a reduced FOV. From the first band 232, the light 218b moves to at least a second band 234. From the second band 234 the light 218c moves towards the output coupler 108. A plurality of light interaction points 238 across the efficiently laddered EPE 206 are represented in FIG. 2A and FIG. 2B with dashed circles. The light interaction points 238 represent where the light (e.g., the light 218a, the light 218b or the light 218c) may contact the plurality of grating structures 300. The increased grating efficiency across the efficiently laddered EPE 206 increases the output FOV. Specifically, light from the original light path would not appear in the FOV for waveguide combiner 100 because the EPE 106 is cropped. The EPE 106 may be cropped by the edge 116 of the substrate 102. Light (e.g., the light 218a, the light 218b, and the light 218c) transmitted across the waveguide combiner (e.g., the first waveguide combiner 202 or the second waveguide combiner 204) appears in a user FOV 118, as shown in FIG. 1B.

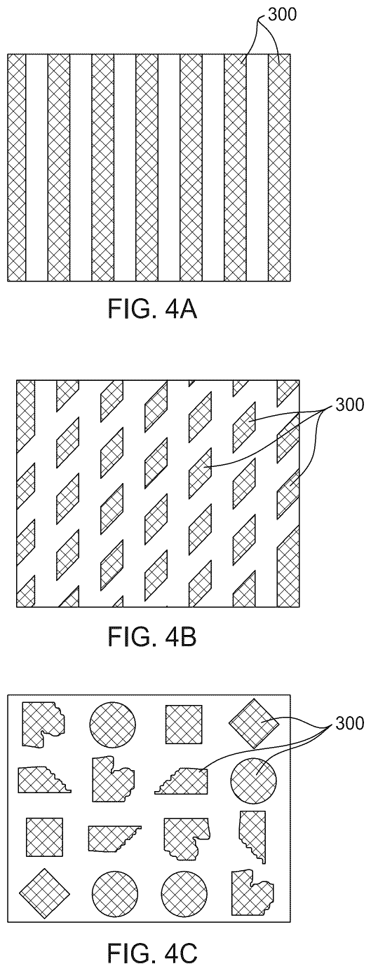

FIGS. 3A, 3C, 3E, 3G, and 3I are examples of schematic top views of a second waveguide combiner 204 having varying efficiently laddered EPE. 206 FIGS. 3B, 3D, 3F, 3H, and 3J are example of cross-sectional side views of a plurality of grating structures 300. FIG. 3K is an example of a schematic top view of a first waveguide combiner 202. FIG. 3L is an example of a cross-sectional side view of a plurality of grating structures 300. The first waveguide combiner 202 and the second waveguide combiner 204 includes a substrate 102, an input coupler 104, an efficiently laddered EPE 206, and an output coupler 108. The input coupler 104, the efficiently laddered EPE 206, and the output coupler 108 are disposed in, on, or over the substrate 102. The efficiently laddered EPE 206 includes a plurality of grating structures 300. The plurality of grating structures 300 form bands (e.g., a first band 232 or a second band 234) on the efficiently laddered EPE 206. In some embodiments, the plurality of grating structures 300 and the bands (e.g., a first band 232 or a second band 234) are formed in a diagonal pattern. The bands (e.g., the first band 232 and the second band 234) are formed by variations in the grating structures 300. For example, as shown in FIGS. 3A-3J, the bands (e.g., the first band 232 and the second band 234) are shown on the efficiently laddered EPE 206, however, it should be understood that additional bands may be formed on the efficiently laddered EPE 206 in other embodiments. The additional bands may be formed by variations in the grating structures 300 within the additional bands. The plurality of grating structures 300 may be 1-D or 2-D grating shapes. As shown in FIG. 4A, a top view of a 1-D grating shape is shown as an example. As shown in FIG. 4B, a top view of a 2-D grating shape is shown as an example. As shown in FIG. 4C, a top down view of an additional view of the 2-D grating is shown as an example. Examples of varying the plurality of grating structures 300 may include binary gratings, slanted gratings, blazed gratings, or generalized gratings (e.g., gratings with an organic shape). The plurality of grating structures 300 direct light away from the edge 116 of the substrate 102 towards an output coupler 108, as described above. The plurality of grating structures 300 efficiency ranges may range from about 0% to about 15%, though other values are contemplated. Variable grating efficiency may be achieved through variable pitch, duty cycle, and/or depth of the plurality of grating structures 300.

As shown in FIG. 3A and FIG. 3B, the plurality of grating structures 300, disposed on a second waveguide combiner 204, include a depth variation 302. FIG. 3B shows a cross section along line A′ to A″ shown in FIG. 3A. The depth 302a of the plurality of grating structures 300 is about 300 nm or less. The change in depth 302a across the efficiently laddered EPE 206 affects the shape of the first band 232 and the second band 234.

As shown in FIG. 3C and FIG. 3D, the plurality of grating structures, disposed on a second waveguide combiner 204, include a duty cycle variation 304. FIG. 3D shows a cross section along line B′ to B″ shown in FIG. 3C. A duty cycle is determined by dividing the critical dimension 304a (e.g., the width) of a grating structure of the plurality of grating structures 300 by the pitch 304b (e.g., the distance between the first edges) of the grating structure. The duty cycle variation 304 is about 0.1 to about 0.9. The duty cycle variation 304 across the efficiently laddered EPE 206 affects the shape of the first band 232 and the second band 234.

As shown in FIGS. 3E and 3F, the plurality of grating structures 300, disposed on a second waveguide combiner 204, include a pitch variation 306. FIG. 3F shows a cross section along line C′ to C″ shown in FIG. 3E. Pitch variation 306 is defined by the distance between the first edges 306a of the plurality of grating structures 300. The pitch variation 306 is about −10 Λ about 10 Λ. The pitch variation 306 across the efficiently laddered EPE 206 affects the shape of the first band 232 and the second band 234.

As shown in FIGS. 3G and 3H, the plurality of grating structures 300, disposed on a second waveguide combiner 204, include a second variable depth 308. FIG. 3H shows a cross section along line D′ to D″ shown in FIG. 3G. The second variable depth 308 forms a first band 232 on the efficiently laddered EPE 206 (e.g., one band forms on the efficiently laddered EPE 206). The first band 232 forms where the depth 308a is larger when compared to other areas on the grating for example 308b.

As shown in FIG. 3I and FIG. 3J, the plurality of grating structures 300 disposed on a second waveguide combiner 204, include a second pitch variation 310. FIG. 3J shows a cross section along line E′ to E″ shown in FIG. 3I. The second pitch variation 310 includes a change in pitch 310a that forms a first band 232 (e.g., one band forms on the efficiently laddered EPE 206). The first band 232 forms where the pitch 310a varies when compared to other areas in the plurality of grating structures 300, for example pitch 310b.

As shown in FIG. 3K and FIG. 3L, the plurality of grating structures, disposed on a first waveguide combiner 202, include a duty cycle variation 304. FIG. 3L shows a cross section along line F′ to F″ shown in FIG. 3K. A duty cycle is determined by dividing the critical dimension 304a (e.g., the width) of a grating structure of the plurality of grating structures 300 by the pitch 304b (e.g., the distance between the first edges) of the grating structure. The duty cycle variation 304 is about 0.1 to about 0.9. The duty cycle variation 304 across the efficiently laddered EPE 206 affects the shape of the first band 232 and the second band 234.

The present disclosure provides a device with an efficiently laddered EPE. The efficiently laddered EPE promotes multiple interactions with light as the light moves laterally within the EPE. The interactions direct the light away from a cropped region of the waveguide or EPE and towards the output coupler. The cropped region may include an edge of the waveguide combiner or the edge of the substrate the waveguide combiner is disposed on. The controlled direction of light within the efficiently-laddered EPE allows for a large user field of view (FOV), flexibility in the layout design of the waveguide combiner, and for the waveguide combiner to be lighter allowing for easy all day wear by the user.

While the foregoing is directed to embodiments of the present disclosure, other and further embodiments of the disclosure may be devised without departing from the basic scope thereof, and the scope thereof is determined by the claims that follow.

What is claimed is:

1. A device, comprising:
a waveguide combiner, the waveguide combiner comprising:
an input coupler operable to receive a light and in-couple the light into the waveguide combiner;
an exit pupil expander (EPE) adjacent to a grating of the input coupler, the EPE having a laddered structure, the laddered structure comprising at least one band, the at least one band comprising a plurality of grating structures, at least one grating structure of the plurality of grating structures has a varying depth, a varying duty cycle, or a varying pitch that is different than a depth, a duty cycle, or pitch than an adjacent grating structure of the plurality of grating structures; and
an output coupler operable to receive the light from the EPE and transmit the light onto a user field of view (FOV).

2. The device of claim 1, further comprising:
a light engine disposed above the waveguide combiner with a pupil above the input coupler.

3. The device of claim 1, wherein the plurality of grating structures comprise the varying depth.

4. The device of claim 1, wherein the plurality of grating structures comprise the varying duty cycle.

5. The device of claim 1, wherein the plurality of grating structures comprise the varying pitch.

6. The device of claim 1, wherein the plurality of grating structures include a 1-D structure.

7. The device of claim 1, wherein the plurality of grating structures include a 2-D structure.

8. The device of claim 1, wherein the laddered structure is disposed across the EPE in a diagonal pattern.

9. The device of claim 1, wherein the EPE comprises a first boundary, a second boundary, and a third boundary and wherein at least one of a portion of the first boundary, the second boundary, or the third boundary is conformal to an edge of a substrate.

10. The device of claim 1, wherein the waveguide combiner comprises a rounded edge portion.

11. The device of claim 10, wherein a portion of the EPE is conformal to the rounded edge portion.

12. The device of claim 1, wherein the laddered structure has a grating efficiency value.

13. A device, comprising:
a substrate;
a light engine disposed above the substrate;
a waveguide combiner disposed on the substrate, the waveguide combiner comprising:
an input coupler operable to receive a light and in-couple the light into the waveguide combiner;
an exit pupil expander (EPE) adjacent to a grating of the input coupler, the EPE having a laddered structure, the laddered structure comprising at least one band, the at least one band comprising a plurality of grating structures, at least one grating structure of the plurality of grating structures has a varying depth, a varying duty cycle, or a varying pitch that is different than a depth, a duty cycle, or pitch than an adjacent grating structure of the plurality of grating structures; and
an output coupler operable to receive the light from the EPE and transmit the light onto a user field of view (FOV); and
the user FOV disposed adjacent to the waveguide combiner, the user FOV operable to receive the light from the waveguide combiner and display the light.

14. The device of claim 13, wherein the EPE comprises at least two bands.

15. The device of claim 10, wherein the laddered structure is disposed across the EPE in a diagonal orientation.

16. The device of claim 13, wherein the laddered structure has a grating efficiency value, the grating efficiency value based, at least in part, on at least one of the pitch, the duty cycle, and the depth of the laddered structure.

17. A method, comprising:
in-coupling a light into a waveguide combiner, the waveguide combiner comprising:
an input coupler operable to receive the light;
an exit pupil expander (EPE) adjacent to a grating of the input coupler, the EPE having a laddered structure, the laddered structure comprising at least one band, the at least one band comprising a plurality of grating structures, at least one grating structure of the plurality of grating structures has a varying depth, a varying duty cycle, or a varying pitch that is different than a depth, a duty cycle, or pitch than an adjacent grating structure of the plurality of grating structures; and
an output coupler;
reflecting the light at the EPE;
interacting the light within the EPE with the plurality of grating structures; and
out-coupling the light at the output coupler, the output coupler operable to receive the light from the EPE and transmit the light onto a user field of view (FOV).

18. The method of claim 17, further comprising:
interacting the light within the EPE at a plurality of light interaction points; and
directing the light away from an edge of the waveguide combiner of the EPE with the plurality of grating structures.

19. The method of claim 17, wherein a plurality of light beams are directed into the waveguide combiner.

20. The method of claim 17, wherein the laddered structure has a grating efficiency value, the grating efficiency value based, at least in part, on at least one of a pitch, a duty cycle, and a depth of the plurality of grating structures.
